(19) United States
(12) Patent Application Publication
(10) Pub. No.: US 2007/0262571 A1
(43) Pub. Date: Nov. 15, 2007

(54) Occupant restraint system

(75) Inventors: Jorg Ruschulte, Richenbach (DE); Heniz Busskamp, Rheinfelden (DE)

Correspondence Address: HARNESS, DICKEY & PIERCE, P.L.C., P.O. BOX 828, BLOOMFIELD HILLS, MI, 48303, US

(73) Assignee: BST Safety Textiles GmbH, Maulburg (DE)

(21) Appl. No.: 11/827,421

(22) Filed: Jul. 11, 2007

Related U.S. Application Data
(63) Continuation of application No. PCT/EP2005/013589, filed on Dec. 16, 2005.

(30) Foreign Application Priority Data
Jan. 21, 2005 (DE) 10 2005 002 962.0

(51) Int. Cl. B60R 21/233

(52) U.S. Cl. 280/729

(57) ABSTRACT

The invention relates to an occupant restraint system for land, water, space or aircraft, in particular motor vehicles, the system including at least two airbags, which can be inflated in the event of a vehicle collision. The system includes devices which are suitable for interconnecting the air bags at least temporarily in the event of a collision.

### CROSS REFERENCE TO RELATED APPLICATIONS

This application is a continuation application of PCT Application Serial No. PCT/EP2005/013589, filed Dec. 16, 2005, which claims priority to German Application No. 10 2005 002 962.0, filed Jan. 21, 2005; both of these applications are incorporated by reference herein.

### BACKGROUND AND SUMMARY

The present invention relates to an occupant restraint system for air, land, sea and space vehicles, particularly motor vehicles comprising at least two air bags for inflation in the event of a vehicle collision.

A wealth of different air bag systems or arrangements of several air bags in vehicles are known which are intended to protect a vehicle occupant from side or front impact in the event of a collision. The occupant restraint systems configured as air bag systems are intended to prevent vehicle occupants from impacting a hard vehicle structure and to cushion passengers with restraint systems, such as, for example, air bags. It has been discovered that all of these devices have a big disadvantage, they namely not being adapted to each other, so that although a whole series of air bag systems exists in the vehicles, it is still possible that passengers impact a hard vehicle structure between the air bags even when the air bags are in contact with each other. The consequences of this are then fatal for the vehicle occupant who, although surrounded by a series of air bags, is still not fully protected from impacting certain structures in the vehicle, especially when the passenger at the moment of collision was “out of position”, in other words not normally seated. Very serious injuries can result which are unavoidable with air bags even working correctly according to the current standard. The invention is based on the object of proposing a vehicle occupant restraint system which avoids or at least greatly diminishes the drawbacks known from prior art.

This object is achieved by an occupant restraint system as it reads from claim 1 which is characterized by means suitable to interlink air bags at least temporarily in the event of a collision. This configuration of the occupant restraint system in accordance with the invention has the major advantage that passengers are now protected on all sides from impacting structural components of the vehicle by interlinked air bags in the event of a collision. Linking the air bags at least temporarily is intended to last at least for the time as of collision until the vehicle has come to rest, but then to automatically release so as not to obstruct rescue efforts.

In one advantageous further development of the invention the air bags comprise means suitable to interlink the air bags. In an advantageous aspect of the invention the system is characterized by air bags which on inflation deploy expansions which nest in recesses of neighboring air bags. This may take the form, for example, of a tongue and groove joint as known in corner joining drawers. In this arrangement the tongues of each air bag can deploy so timed to interlink that in the fully deployed condition a firm link is created which is also capable of withstanding passenger impact.

In a further advantageous aspect of the invention the expansions are configured lockable with the recesses, resulting in an even more secure and firm temporary link of neighboring air bags. In another advantageous aspect of the system in accordance with the invention means are provided which are suitable to move and link the air bags targeted to each other. These means do not need to be arranged directly on the air bags themselves, as described above, instead they may consist of straps which regulate the local deployment of the air bags on inflation in moving them to each other. This is achievable to advantage by straps which tug the air bags together.

### BRIEF DESCRIPTION OF THE DRAWINGS

For a better appreciation of the invention, it will now be briefly detailed by way of example embodiments with reference to the drawing in which:

FIG. 1 is a greatly simplified diagrammatic side view of a side air bag provided with a recess for a front or driver/front seat passenger air bag;

FIG. 2a is a greatly simplified diagrammatic view of a front air bag in the deployed condition with an expansion which nests in the recess of the side air bag as shown in FIG. 1;

FIG. 2b is again a greatly simplified diagrammatic view of a front air bag in another version of the air bag as shown in FIG. 2a with a locking expansion for locking with a side air bag as shown in FIG. 1, for example;

FIG. 3 is a greatly simplified diagrammatic section of a situation showing a side air bag and a front air bag interlinked;

FIG. 4 is an illustration similar to that of FIG. 1 of a side air bag having an alternative recess for receiving an expansion of a neighboring air bag;

FIG. 5a is a diagrammatic section view of an expansion of the front air bag for linking with a recess of a side air bag as shown in FIG. 4; and

FIG. 5b is an illustration of a variant of that as shown in FIG. 5a which likewise nests in a recess of a side air bag as shown in FIG. 4 diagrammatically.

### DETAILED DESCRIPTION

Referring now to FIG. 1 there is illustrated an occupant restraint system in accordance with the invention containing, for example, a side air bag 1 and a driver air bag. From experience and because of the little spacing from the passenger, for example, the driver to the side structure of a vehicle, the side air bag 1 needs to be inflated quicker than a front air bag which as compared to the side air bag has a greater spacing from the vehicle occupant. The side air bag 1 as shown in FIG. 1 has in the direction of the arrow V, i.e. in the side pointing in the forwards direction a recess 2 which extends for example through the wall of the side air bag 1. Indicated on the side of the side air bag as shown in FIG. 1 pointing in the direction of the arrow H, i.e. rearwards, is a gas inlet 3 through which the side air bag 1 can be filled with inflation gas.

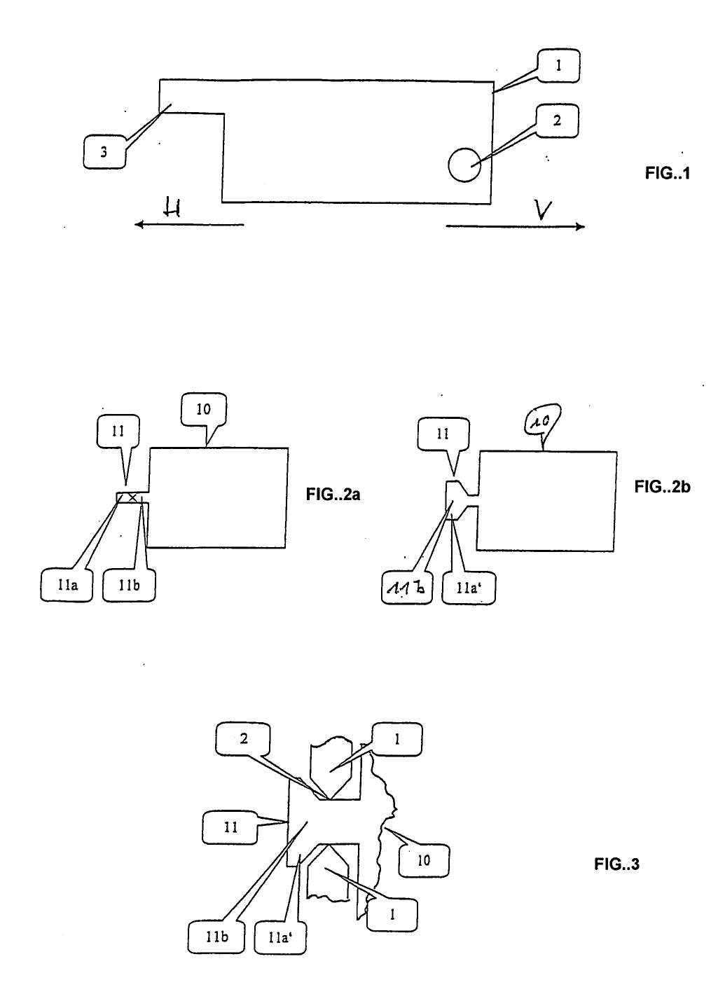

Referring now to FIG. 2a there is illustrated a driver air bag 10 in the inflated condition showing configured on one side a tongue 11. On inflation the driver air bag 10 is deployed as such, before the middle part 11b of the tongue 11 is deployed. When the driver air bag 10 as well as the tongue 11 are correctly deployed they are positioned directly facing the recess 2 of the side air bag 1 as shown in FIG. 1. In subsequent deployment of the tongue 11 the middle part 11b moves through the recess 2. Advantageously the end of the tongue 11 is dimensioned larger than the recess 2 so that a return movement of the tongue 11 from the recess 2 after deployment of the tongue 11 is no longer possible in thus producing a firm link between the two air bags, i.e. side air bag 1 and front air bag 10.

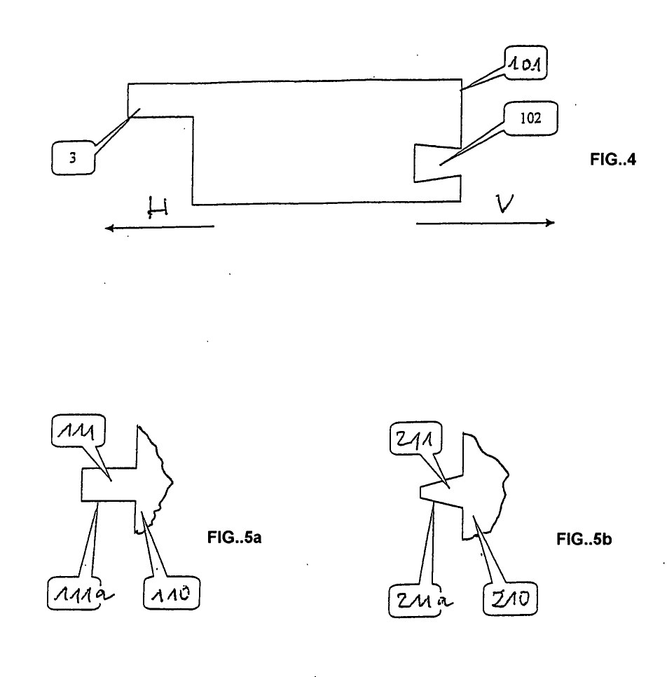

Referring now to FIG. 2b there is illustrated diagrammatically the widening 11a′ of the end of the tongue 11, here having the shape of a hammer head. Clearly evident qualitatively from FIG. 3 although on a somewhat magnified scale, i.e. not true to scale is how the two air bags each shown in part, namely side air bag 1 (in section through the recess 2) and front air bag 10 are linked, it being well evident how the hammer head shaped widening of the tongue 11 extends through the recess 2 of the side air bag 1. Following the collapse in pressure after a collision, this link is very easy to release, i.e. rescue personnel needing to gain access to injured passengers without delay, or also the passengers themselves wanting to abandon the vehicle after the collision are not obstructed by interlinked air bags which after being collapsed can be simply shifted and separated.

Referring now to FIG. 4 there is illustrated a variant of the recesses relevant to a side air bag 101. Evident is the dovetailed recess 102 in the front portion of the side air bag 101 into which a corresponding tongue 111, e.g. of a front air bag 110 as shown in FIG. 5a in part with a corresponding contour 111a nests. In the FIGS. 1 and 4 the locations of the corresponding side air bags are indicated by the arrows H for rear and V for front. As already mentioned this is intended to show by example how in the front portion of a side air bag a link to a front air bag is made possible. It is, of course, understood that the invention is not restricted to the examples as shown in this case. Linking two adjoining front air bags or also other neighboring side, head, lap air bags, etc. is likewise possible with the occupant restraint system in accordance with the invention.

Referring now to FIG. 5b there is illustrated sectionwise a front air bag 210 with a tongue 211a attached thereto and which in this case is configured conical for nesting in a corresponding conical recess (not shown) at a corresponding location in a side air bag configured in principle in accordance with the invention, by which it can be linked thereto.

The present invention relates to an occupant restraint system for air, land, sea and space vehicles, particularly motor vehicles comprising at least two air bags, both of which preferably comprise two one-part air bags or at least one air bag configured at least in two parts, or combinations thereof. Air bags currently employed all work as isolated achievements for cushioning vehicle occupants. In this arrangement air bag systems working simultaneously such as side, roof and front air bags are not adapted to each other. One object of the present invention is to realize linking or timing air bags each working temporarily alone to now provide all-round protection for passengers in a vehicle. In addition to this there is the further advantageous aspect, namely that the air bags when linked in position stabilize each other as a “closed cage”. This relates particularly to air bags deployed from the upper region of a vehicle, which are not positioned in the fixed dashboard region of a vehicle, which because they have only a single fixing point and thus are relatively unstable, are strongly restricted in performance. This restriction is now greatly diminished by stabilizing the air bags as described above by their interlinking.

The advantages of the invention can be further enhanced by interlinking the air bags in an optimally timed deployment of initially independent air bag systems. Based on this approach the advantage is also to be emphasized that the cooperation of singly weaker components by the linking as described above ultimately results in strengthening of individual components. The result of this is that on the basis of these considerations the individual component can now be configured weaker as compared to components as currently known in ultimately achieving also a considerable savings in cost whilst improving the interlinking air bag systems and the safety as resulting for the occupants.

The invention claimed is:

1. An occupant restraint system for air, land, sea and space vehicles, particularly motor vehicles, the system comprising at least two air bags for inflation in the event of a vehicle collision, one of the air bags on being inflated comprises deployable expansions which nest in recesses of the other air bag deployed on inflation to interlink the air bags only temporarily in the event of a collision.

2. The system as set forth in claim 1, wherein the air bags further comprise at least: (a) two one-piece air bags, or (b) an at least two-piece air bag, or (c) a combination thereof.

3. The system as set forth in claim 1, wherein the expansions are lockable with the recesses.

4. The system as set forth in claim 1, further comprising means suitable for moving and linking the air bags targeted.

5. The system as set forth in claim 1, further comprising straps capable of tugging the air bags together.

6. An occupant restraint system comprising:
a first airbag including a first structure; and
at least a second airbag including a second structure;
the structures engaging each other during inflation and disengaging from each other after deflation.

7. The system as set forth in claim 6, wherein the structure includes a recess.

8. The system as set forth in claim 6, wherein the structure includes a projecting tongue.

9. The system as set forth in claim 6, wherein the first airbag substantially inflates before the first structure fully inflates.

10. The system as set forth in claim 6, wherein at least one of the structures inflates.

11. The system as set forth in claim 6, wherein the structures have a tongue and groove configuration.

12. The system as set forth in claim 6, wherein the structures have a projection and hole configuration.

13. The system as set forth in claim 6, wherein the first airbag is a front motor vehicle airbag and the second airbag is a side motor vehicle airbag.

14. The system as set forth in claim 6, wherein at least one of the airbags is a one-piece motor vehicle airbag.

15. An occupant restraint system comprising:
a first inflatable airbag;
at least a second inflatable airbag; and
an inflatable interlink operably connecting together the airbags, when inflated.

16. The system as set forth in claim 15, further comprising a recess in the first airbag and the interlink including a projection engaging the recess when inflated.

17. The system as set forth in claim 15, wherein the first airbag substantially inflates before the interlink fully inflates.

18. The system as set forth in claim 15, wherein the interlink automatically disconnects the airbags after deflation.

19. The system as set forth in claim 15, further comprising a tongue and groove configuration includes the interlink.

20. The system as set forth in claim 15, wherein the first airbag is a front motor vehicle airbag and the second airbag is a side motor vehicle airbag.
